(19) United States
(12) Patent Application Publication
(10) Pub. No.: US 2025/0289135 A1
(43) Pub. Date: Sep. 18, 2025

(54) Robot System

(71) Applicants: TE Connectivity Solutions GmbH, Schaffhausen (CH); Tyco Electronics (Shanghai) Co., Ltd., Shanghai (CN)

(72) Inventors: Liao (Leo) Chen, Shanghai (CN); Xianghao (Jorge) Bao, Shanghai (CN); Dandan (Emily) Zhang, Shanghai (CN); Roberto Francisco-Yi Lu, Bellevue, WA (US)

(73) Assignees: TE Connectivity Solutions GmbH, Schaffhausen (CH); Tyco Electronics (Shanghai) Co., Ltd., Shanghai (CN)

(21) Appl. No.: 19/079,790

(22) Filed: Mar. 14, 2025

(30) Foreign Application Priority Data
Mar. 15, 2024 (CN) 202410296665.5

(51) Int. Cl. B25J 9/16; B25J 5/00; G06V 10/26; G06V 40/10; G06V 40/20

(52) U.S. Cl. CPC B25J 9/1676; B25J 9/1697; G06V 10/26; G06V 40/10; G06V 40/20; B25J 5/00

(57) ABSTRACT

A robot system includes a robot and a vision device. The vision device includes an imaging module, a partition module, a recognition module, and a control module. The imaging module captures a real-time video image of a work site of the robot. The partition module divides the captured video image into a plurality of different areas. The recognition module recognizes whether a person has entered the plurality of different areas. The control module communicates with the robot and controls the robot based on a recognition result of the recognition module. The plurality of different areas includes a first virtual barrier area surrounding the robot. When the recognition module recognizes that a person has entered the first virtual barrier area the control module sends a stop operation control instruction to the robot, stopping the robot immediately.

### CROSS-REFERENCE TO RELATED APPLICATION

This application claims the benefit of the filing date under 35 U.S.C. § 119(a)-(d) of Chinese Patent Application No. CN202410296665.5 filed on Mar. 15, 2024.

### FIELD OF THE INVENTION

The present invention relates to a robot system and, more particularly, to a robot system without physical guardrails.

### BACKGROUND OF THE INVENTION

In the prior art, in order to ensure safety, it is usually necessary to set up fixed guardrails around a robot. During the operation of the robot, the door of the guardrail is closed to prevent people from entering the guardrail. However, setting up fixed guardrails is very inconvenient. In addition, for mobile robots that need to be applied to different production equipment, due to the need to move between different production equipment, it is not possible to set fixed guardrails around the robot, as guardrails will affect the docking between the robot and different production equipment. Therefore, in the prior art, there are no guardrails around mobile robots that need to move between different production equipment, which can lead to serious safety hazards.

### SUMMARY OF THE INVENTION

A robot system includes a robot and a vision device. The vision device includes an imaging module, a partition module, a recognition module, and a control module. The imaging module captures a real-time video image of a work site of the robot. The partition module divides the captured video image into a plurality of different areas. The recognition module recognizes whether a person has entered the plurality of different areas. The control module communicates with the robot and controls the robot based on a recognition result of the recognition module. The plurality of different areas includes a first virtual barrier area surrounding the robot. When the recognition module recognizes that a person has entered the first virtual barrier area the control module sends a stop operation control instruction to the robot, stopping the robot immediately.

### BRIEF DESCRIPTION OF THE DRAWINGS

The invention will now be described by way of example with reference to the accompanying figures, of which:

FIG. 1 is a block diagram of a robot system according to an exemplary embodiment; and

FIG. 2 is a functional block diagram of a vision device according to an exemplary embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

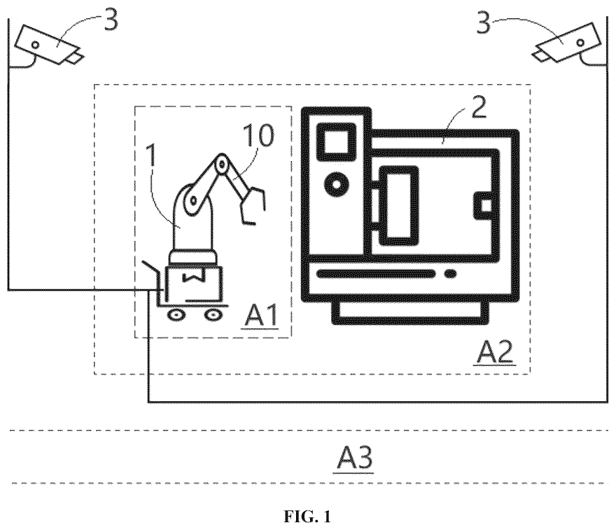

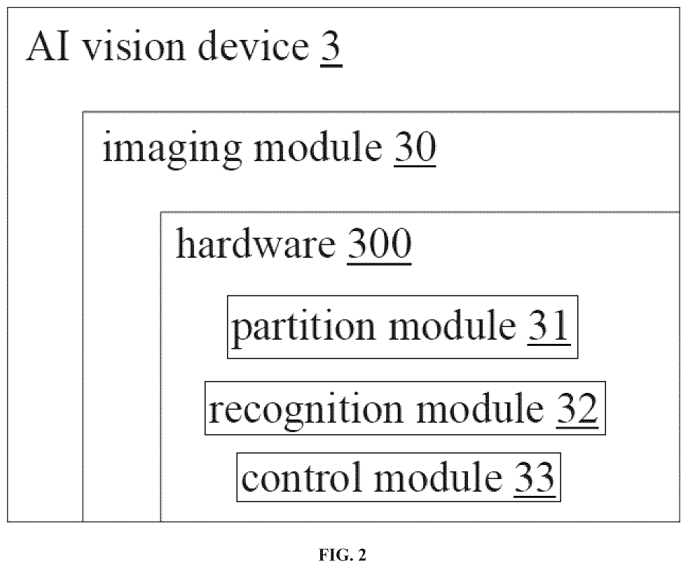

An exemplary embodiment of a robot system will now be described with reference to FIGS. 1-2. The robot system comprises a robot 1 and a vision device 3. The vision device 3, as shown in FIG. 2, includes an imaging module 30, a partition module 31, a recognition module 32, and a control module 33. The imaging module 30 is used to capture a real-time video image of a work site of the robot 1. The partition module 31 is used to divide the captured video image into multiple different areas A1, A2, A3. The recognition module 32 is used to recognize whether someone has entered any of the multiple different areas A1, A2, A3. The control module 33 communicates with the robot 1 and is used to control the robot 1 based on the recognition results from the recognition module 32.

As shown in FIGS. 1-2, the recognition module 32 has undergone large-scale model training and can effectively recognize human features and behaviors. In an embodiment, the vision device 3 incorporates Artificial Intelligence. In an exemplary embodiment, the recognition module 32 is an artificial intelligence vision system that has undergone large-scale model training and can effectively recognize human features and behaviors.

As shown in FIG. 1, the multiple different areas A1, A2, A3 include a first virtual guardrail area Al surrounding the robot 1. When the recognition module 32 recognizes that someone has entered the first virtual guardrail area A1, the control module 33 sends a stop operation control instruction to the robot 1, to control the robot 1 to immediately stop the operation.

As shown in FIG. 1, the multiple different areas A1, A2, A3 also include a second virtual barrier area A2 surrounding the first virtual barrier area A1. When the recognition module 32 recognizes that no one has entered the first virtual barrier area Al but recognizes that someone has entered the second virtual barrier area A2, the control module 33 sends a deceleration operation control instruction to the robot 1 to control the robot 1 to reduce the operation speed.

As shown in FIG. 1, the multiple different areas A1, A2, A3 also include a safety area A3 located outside the second virtual barrier area A2. When the recognition module 32 recognizes that no one has entered the first and second virtual barrier areas Al and A2, but recognizes that someone has entered the safety area A3, the control module 33 sends a normal operation control instruction to robot 1 to allow it to operate normally.

As shown in FIG. 1, the robot system further includes a production equipment 2. The robot 1 is applied to the production equipment 2. The robot 1 is located in the first virtual barrier area A1, while the production equipment 2 is located outside the first virtual barrier area A1 but in the second virtual barrier area A2.

As shown in FIG. 1, the robot 1 is a mobile robot 1 and is adapted to move between different production equipment 2, enabling the Robot 1 to be applied to different production equipment 2. In the illustrated embodiment, due to the absence of fixed guardrails around the robot 1, the robot 1 can freely move between different production equipment 2 and easily dock with different production equipment 2.

The recognition module 32, as shown in FIG. 2, can only recognize features of a human body, and cannot recognize features of objects other than the features of the human body. The recognition module 32 will allow objects other than features of the human body to enter the first virtual barrier area A1 and the second virtual barrier area A2. Human body features include head features, body features, hand features, and foot features.

When any one of the head features, body features, hand features, or foot features of the person is recognized in the first virtual barrier area A1 or the second virtual barrier area A2, the recognition result of the recognition module 32 is that a person has entered the first virtual barrier area A1 or the second virtual barrier area A2.

When none of the head features, body features, hand features, or foot features of the person are recognized in the first virtual barrier area A1 or the second virtual barrier area A2, the recognition result of the recognition module 32 is that no one has entered the first virtual barrier area Al or the second virtual barrier area A2.

The imaging module 30, as shown in FIG. 2, includes a camera. The partition module 31, recognition module 32, and control module 33, as shown in FIG. 2, are functional modules integrated into hardware 300 of the camera. As shown in FIG. 1, the control module 33 is connected to the robot 1 through signal lines to communicate with the robot 1.

When the recognition module 32 recognizes that someone has entered the first virtual guardrail area A1, the control module 33 controls a moving part 10 of the robot 1 to immediately stop the moving part 10 from moving. When the recognition module 32 recognizes that no one has entered the first virtual barrier area Al but recognizes that someone has entered the second virtual barrier area A2, the control module 33 controls the moving part 10 of the robot 1 to reduce the movement speed of the moving part 10. When the recognition module 32 recognizes that no one has entered the first virtual barrier area Al and the second virtual barrier area A2, the moving part 10 of robot 1 is not affected and moves normally. As shown in FIG. 1, the moving part 10 of robot 1 includes a robotic arm.

As shown in FIG. 1, the robot system includes multiple vision devices 3, which are respectively set at multiple different locations and in multiple different orientations. This can improve the safety level of the robot system. When a certain visual device 3 malfunctions, other visual devices 3 can continue to provide safety protection.

When the robot 1 receives a control instruction to stop operation from any of the multiple vision devices 3, the robot 1 immediately stops working. After the robot 1 stops working, it is necessary to manually restart the entire robot system.

When the robot 1 does not receive a control instruction to stop the operation but receives a control instruction to slow down the operation from any one of the multiple vision devices 3, the robot 1 immediately reduces the operation speed. After the robot 1 reduces its operating speed, if personnel entering the second safety barrier area A2 leave, the robot 1 can automatically resume normal operations under the control of the vision device 3.

When the robot 1 receives both the control instruction to stop the operation and the control instruction to decelerate the operation, the robot 1 immediately stops working.

In the aforementioned exemplary embodiments according to the present invention, the vision device 3 sets the virtual barrier areas A1, A2, A3 for the robot 1 and can recognize whether the person has entered any of the virtual barrier areas A1, A2, A3. When recognizing that someone has entered the virtual barrier areas A1, A2, the vision device 3 will control the robot 1 to stop operation or reduce the working speed of the moving part 10 of the robot 1, thereby avoiding safety accidents and improving the safety of the robot system without requiring fixed guardrails.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A robot system, comprising:
a robot; and
a vision device including an imaging module capturing a real-time video image of a work site of the robot, a partition module dividing the captured video image into a plurality of different areas, a recognition module recognizing whether a person has entered the plurality of different areas, and a control module communicating with the robot and controlling the robot based on a recognition result of the recognition module, the plurality of different areas includes a first virtual barrier area surrounding the robot, when the recognition module recognizes that a person has entered the first virtual barrier area the control module sends a stop operation control instruction to the robot, stopping the robot immediately.

2. The robot system of claim 1, wherein the plurality of different areas further include a second virtual barrier area surrounding the first virtual barrier area, when the recognition module recognizes that the person has not entered the first virtual barrier area but recognizes that the person has entered the second virtual barrier area, the control module sends a deceleration operation control instruction to the robot to reduce an operation speed of the robot.

3. The robot system of claim 2, wherein the plurality of different areas also includes a safety area located outside the second virtual barrier area, when the recognition module recognizes that the person has not entered the first virtual barrier area and the second virtual barrier area but recognizes that the person has entered the safety area, the control module sends a normal operation control instruction to the robot allowing the robot to operate normally.

4. The robot system of claim 2, further comprising production equipment located outside the first virtual barrier area but in the second virtual barrier area, the robot located in the first virtual barrier area is applied to the production equipment.

5. The robot system of claim 4, wherein the robot is a mobile robot that docks to the production equipment and other different production equipment.

6. The robot system of claim 2, wherein the recognition module only recognizes features of a human body and cannot recognize features of objects other than the human body, the recognition module allows objects other than features of the human body to enter the first virtual barrier area and the second virtual barrier area.

7. The robot system of claim 6, wherein the features of the human body include head features, body features, hand features, and foot features.

8. The robot system of claim 7, wherein when any one of the features of the human body are recognized in the first virtual barrier area or the second virtual barrier area, the recognition result of the recognition module is that the person has entered the first virtual barrier area or the second virtual barrier area.

9. The robot system of claim 7, wherein when none of the features of the human body are recognized in the first virtual barrier area or the second virtual barrier area, the recognition result of the recognition module is that the person has not entered the first virtual barrier area or the second virtual barrier area.

10. The robot system of claim 1, wherein the imaging module includes a camera having hardware, the partition module, the recognition module, and the control module are functional modules integrated into the hardware, the control module is connected to the robot through a signal line to communicate with the robot.

11. The robot system of claim 1, wherein the robot includes moving parts, the moving parts include a robotic arm, when the recognition module recognizes that the person has entered the first virtual barrier area, the control module controls the moving parts to immediately stop the moving parts from moving.

12. The robot system of claim 2, wherein the robot includes moving parts, the moving parts include a robotic arm, when the recognition module recognizes that the person has not entered the first virtual barrier area but recognizes that the person has entered the second virtual barrier area, the control module controls the moving parts to reduce a movement speed of the moving parts.

13. The robot system of claim 2, wherein the robot includes moving parts, the moving parts include a robotic arm, when the recognition module recognizes that the person has not entered the first virtual barrier area and the second virtual barrier area, the moving parts of the robot continue moving normally.

14. The robot system of claim 1, wherein the robot system comprises a plurality of vision devices, the plurality of vision devices are respectively set at multiple different locations and in multiple different orientations.

15. The robot system of claim 14, wherein when the robot receives the stop operation control instruction from any of the plurality of vision devices, the robot immediately stops working.

16. The robot system of claim 15, wherein when the robot does not receive the stop operation control instruction but receives a deceleration operation control instruction from any of the plurality of vision devices, the robot immediately reduces an operation speed.

17. The robot system of claim 16, wherein when the robot receives both the stop operation control instruction and the deceleration operation control instruction, the robot immediately stops working.

18. The robot system of claim 1, wherein the recognition module is an artificial intelligence vision system that has undergone large-scale model training and can effectively recognize human features and behaviors.
